(19) United States
(12) Patent Application Publication
(10) Pub. No.: US 2002/0141812 A1
(43) Pub. Date: Oct. 3, 2002

(54) Spring assisted telescoping pole assembly

(76) Inventors: William A. Edelen, Louisville, KY (US); John D. Sherman, Louisville, KY (US)

Correspondence Address: WILLIAM A. EDELEN, 115 N. WATTERSON TRAIL, LOUISVILLE, KY, 40243, US

(21) Appl. No.: 09/681,411

(22) Filed: Mar. 30, 2001

(51) Int. Cl. F16B 7/10

(52) U.S. Cl. 403/109.1

(57) ABSTRACT

An adjustable telescoping utility pole apparatus formed from a number of inter-received tubular members, compression springs and a novel release assembly mechanism. Each tubular member is self extended via the compression spring and controlled by the release mechanism located in the base handle assembly.

### FEDERAL RESEARCH STATEMENT

[Federal Research Statement Paragraph] Not Applicable

### BACKGROUND OF INVENTION

The present invention relates generally to an adjustable telescoping utility pole comprising a plurality of hollow tubular members and a novel apparatus of suitably sized lightweight compression springs to assist or self-extend each and every section of the tubular assembly with the touch of a button. The pole has a variety of applications golf ball retriever, photographic tripod legs, extending light bulb changers or paint pole extensions. More particularly, this invention relates to novel apparatus of releasing a nylon cord connecting the tubular sections, being thrust along the axis of the tubular members via the compression springs located in each section of the telescoping pole.

Telescoping poles are generally comprised of multiple hollow tubular sections that are slideably received within each other, thereby allowing the pole to be extended and retracted to various lengths. The extension range, and resulting length, of a telescoping pole is generally based upon the number and length of the individual tubular sections that make up the pole. A pole comprised of a greater number of sections of equivalent length will extend farther than a similar pole comprised of fewer sections of the same length. As such, the length of a fully extended telescoping pole may be increased by either increasing the length of the tubular sections, or by increasing the number of sections. Each pair of tubular sections can be described as a receiving section and a received section. The received tubular section fits slideably within the receiving tubular section. The inner diameter of the receiving tubular section is sized equal to, or slightly larger than, the outer diameter of the internally received tubular section. This internally received tubular section may also be hollow itself and slideably receiving in another internal section which has an outer diameter sized in the same relationship as stated above. Collectively, this arrangement of internally positioning a number of tubular sections is used to create telescoping poles in a variety of lengths and diameters that are used in a variety of intermittently extended states. Typically, the length of extension and diameter of the tubular sections is dictated by the pole's application. Some telescoping poles are used for a specific purpose while in an extended position and are then stored in a retracted position when not in use.

The telescoping pole has and is being used for a multitude of uses, from golf ball retrievers to raising and leveling a camera or video tripod on a stationary setting. While in each of these applications each section of the tubular assembly must be extended and retracted by hand, thus becoming cumbersome and time consuming. The present invention is directed an improved telescopic pole that can be easily extended partially or in full with the touch on a button.

### SUMMARY OF INVENTION

The present invention relates generally to an adjustable telescoping utility pole comprising a plurality of hollow tubular members and a novel mechanism for releasing each section of the tubular assembly to its extended position with out physically grasping the section and retracting it by hand. More particularly, this invention relates to a novel apparatus for controlling the extension of the tubular sections via the release assembly located in the base section of the tubular assembly. The essence of the present invention is its novel self-extending mechanism. The self-extending mechanism comprises a base section and an engagement section. The base section is generally cylindrical in shape and includes an outer surface. The diameter of the base section is substantially equal to or slightly greater than the diameter of the tubular member into which it fits. The base section houses the release assembly comprised of a spring assisted retracting spool and a latching system triggered via the release button thus allowing the ingress and egress of the nylon cord attached through the tubular assembly allowing the extension of each section to the extent of the length of the nylon cord as well as receiving the nylon cord back on the spool in an orderly fashion as the sections are retraced back into each other.

The telescoping pole of my invention is comprised of multiple inner receiving tubular sections; all having a number of inter-received hollow tubular members each with suitably sized lightweight compression springs. Each tubular member has an upper and lower end. The upper end is comprised of an open receiving with a tubular guide collar. The lower end of the tubular member is comprised of a ultra high molecular weight material or like kind plug or locking device with a suitability-sized hole located in the center of the plug however the lower section plug is inserted halfway into the lower end leaving half of the plug extended beyond the actual tubular member of this section. The outer portion of this plug is sized slightly larger than the tubular member in which it is inserted, to allow the dimpling of the upper end of the receiving tube to act as a stop for the inner tubular member as it is extended to its full potential. The base section is comprised of a handle and release assembly that spools up a nylon cord while in the retracted position. As the release mechanism is activated via the release button placing pressure on the latch, the compression springs are then allowed to extend the tubular sections as much as the individual operating the invention so desires. The length of the full extension is directly related to the number of sections utilized in the current application. The more sections utilized the longer the entire tubular assembly will extend. The nylon cord extending from the coiling spool through each section of the tubular assemblies controls the amount of extension to a point of full extending with the dimple stops acting as the last point of ability to extend. The operator can lightly depress the release button for a short duration, thus allowing only a short run of nylon cord out and releasing the compression springs to extent of the cord. For a longer or complete extension the operator simply holds the release button down until the compression springs are allowed to extend each tubular section to its full extent using the dimpling of the upper end of the tubular section to act as a stop. Also in my preferred embodiment, a utility device, such as a golf ball retriever, is placed on the first end of the first tubular member.

### BRIEF DESCRIPTION OF DRAWINGS

FIG. 1 is a perspective view of the spring assisted telescoping pole, showing a number of tubular sections, guide collars base section and a golf ball retrieving device (shown in phantom).

FIG. 2 is an interior perspective view of the spring assisted telescoping pole assembly with the base handle assembly. It is showing a number of tubular sections, compression springs, guide collars and tubular guide plugs. FIG. 2. also depicts the relationship of the base handle assembly with regard to the novel release mechanism, nylon cord spool and the methodology utilized in the releasing of the tubular sections to an outward extended position with the touch of a button.

FIG. 3 is an exploded view of the base handle assembly with detail call outs.

FIG. 3a is a cross section of the spool/cord area of the base handle assembly. This area I noted on FIG. 3 as Section A A.

FIG. 3B is a cross sectional view of the release button area, depicting it's relationship to the latch. This area is noted on FIG. 3 as B B.

FIG. 3C is the cross sectional view of the cord pulley area that guides the nylon cord from the spool and into the tubular assembly in an orderly fashion. This area is depicted on FIG. 3 as section C C.

FIG. 3D is the cross sections view of the latch and it's offset position on the latch spindle. This is noted on FIG. 3 as section D-D.

FIG. 4 is a side perspective of the tubular guide plug. FIG. 4A is an end perspective of the tubular guide plug.

FIG. 5 is a detailed perspective of the tube guide collar.

### DETAILED DESCRIPTION

Although the disclosure hereof is detailed and exact to enable those skilled in the art to practice the invention, the physical embodiments herein disclosed merely exemplify the invention, which may be embodied in other specific structures. While the preferred embodiment has been described, the details may be changed without departing from the invention, which is defined by the claims.

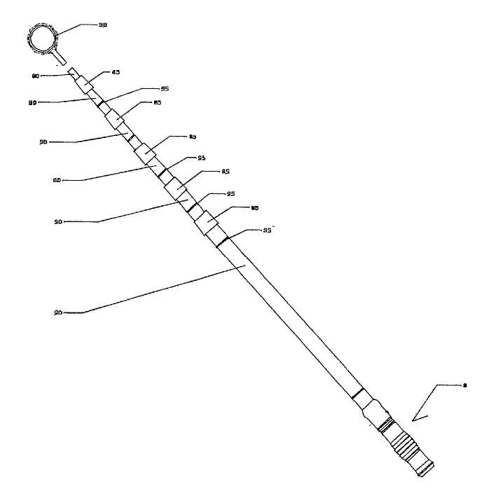

The detailed embodiment of the telescoping pole assembly 9 of FIG. 1 give a full and complete exterior perspective of the invention being utilized as a golf ball retriever, as per the exemplary utility device 96, (shown in phantom). The number of tube sections 90 A, 90 B 90 C, (et al) for this perspective is totaled at (6) six. As previously mentioned, the number of tube sections 90 A, 90 B 90 C, (et al) may be increased or decreased as the need for the particular embodiment chosen. The base handle assembly 8 is located at the lower end of the invention typically attached to the largest of the tube sections 90 A, 90 B 90 C, (et al). Found on the upper end of each tube sections 90 A, 90 B 90 C, (et al) is a guide collar 85, this facilitates a smooth extension and retraction on the longitudinal axis of the tube sections 90 A, 90 B 90 C, (et al) through out the invention. The tubular dimple stop 95 is clearly shown towards the upper end of each tube sections 90 A, 90 B 90 C, (et al) to impede the tube sections 90 A, 90 B 90 C, (et al) once it reaches it's fullest potential.

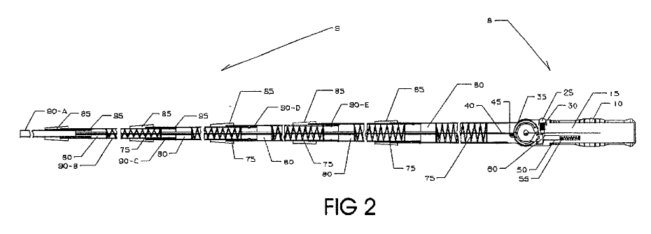

With reference to FIG. 2, it will be noted that the adjustable multi-function telescoping pole 9 and the base section handle assembly 8 of this invention comprises a plurality of hollow tubular sections 90 A, 90 B 90 C, (et al) each with a compliment of a suitably sized guide collar 85, a tubular guide plug 80, and a compression spring 75. While six (6) tubular members are shown, it is to be understood that any number (more or less) could be utilized. With continued reference to FIG. 2, the spring assisted telescoping pole 9 is further characterized by having a suitably sized guide collar 85 located on the forward or receiving end of the tube sections 90 A, 90 B 90 C, (et al) . Shown also in FIG. 2 are tubular guide plugs 80 positioned with the smaller diameter end of tubular guide plug 82 inserted into the lower interior regions of tubular sections 90 A, 90 B 90 C, (et al), and the larger diameter end of tubular guide plug 81 located in the forward or receiving end of the tube sections 90 A, 90 B 90 C, (et al), respectively each tubular guide plug 80 has a plug orifice 83 to allow the nylon cord 40 to freely connect the outer most tube section 90 A, 90 B 90 C, (et al) to traverse each and all tube sections 90 A, 90 B 90 C, (et al) and connect to the nylon cord spool 35 found in the base handle assembly 8 of the invention.

Lightweight compression springs 75 are suitably sized for each tube section 90 A, 90 B 90 C, (et al) of the invention. Each compression spring 75 is located between the lower end of the tubular guide plug 81 of the upper positioned tube section 90 A, 90 B 90 C, (et al), and the upper end of the tubular guide plug 82 of the lower receiving tube section 90 A, 90 B 90 C, (et al). The compression spring 75 is suitably sized with regard to the fully extended length as per the needs of the particular embodiment of the invention. It should be noted that a nylon cord 40 of sufficient extended length, is threaded through the tube sections 90 A, 90 B 90 C, (et al) permanently affixed to the smallest and outermost tube section 90 A, 90 B 90 C, (et al) and to the nylon cord spool 35 found in the base handle assembly 8.

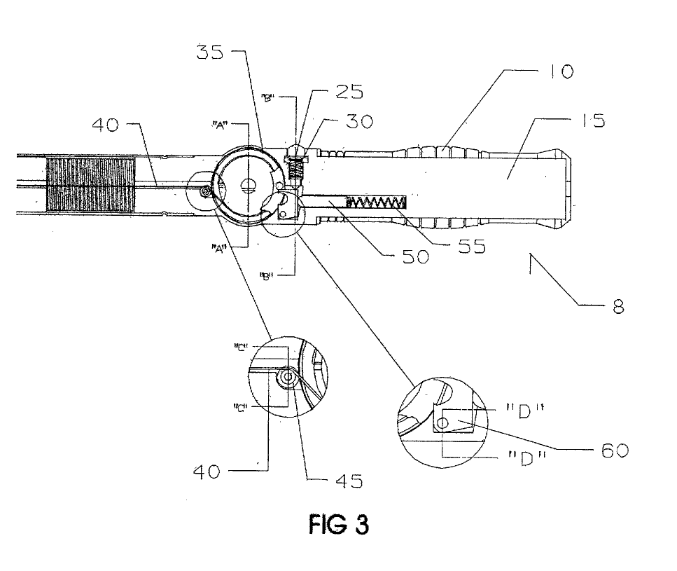

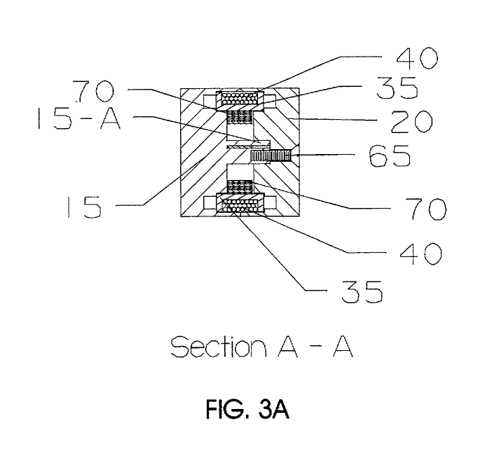

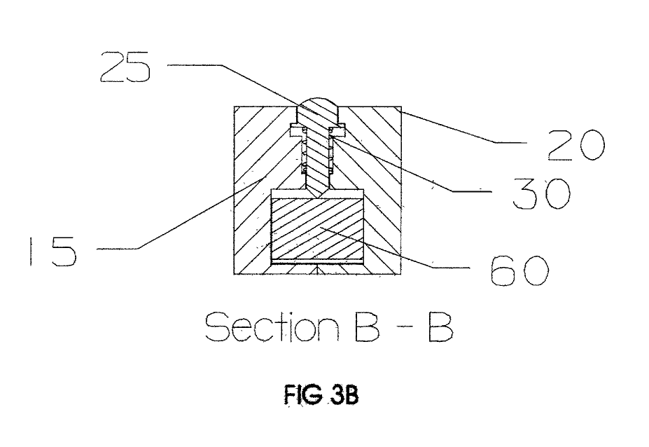

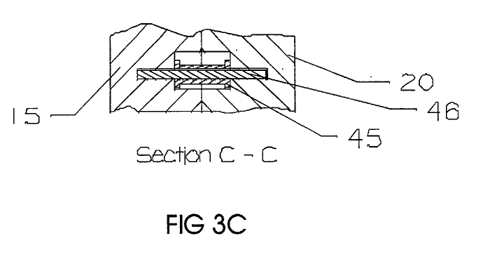

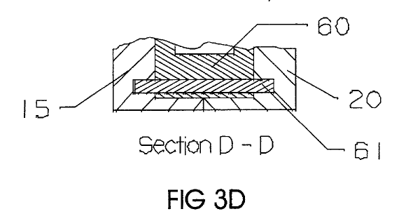

Referring to FIG. 3, it should be noted the base section handle assembly 8 is shown attached to the first and traditionally the largest of the tube sections 90 A, 90 B 90 C, (et al). It should be observed that the base handle assembly 8 is comprised of two halves each, molded plastic handle (R) 15 and molded plastic handle (L) 20, included in the two sections is a novel release apparatus assembly. An integral part of the molded plastic handle (R) 15 is the torsion spindle 15 A as shown in FIG. 3A. The nylon cord spool 35 spins on the axis created by the torsion spindle 15 A and after completion and installation of the balance of the inventions elements, an individual skilled in the art to practice the invention would enclose the opposing side of the base handle assembly 8, with the molded plastic handle (L) 20 held together by a plurality of handle assembly screw 65 or screws. Also attached to the torsion spindle 15 A and located inside the axis of the nylon cord spool 35 is the torsion spring 70, this spring application to the nylon cord spool 35 acts to recoil or retract the nylon cord spool 35 backwards to enable the nylon cord 40 to be completely spooled up or retracted and held in place by the relationship of the spool latch nodule 36 and the latch 60 itself. The spool latch nodule 36, being an integral part of the nylon cord spool 35 can be singular or a plurality of spool latch nodules 36 depending on the embodiment of the invention.

The latch 60, is located on the latch shaft 61, found as an integral part of the molded plastic handle (R) 15, this latch 60, works in a offset pivoting action to release or act as a stop to the nylon cord spool 35 via the spool latch nodule 36. The pivoting action as described above is a direct result of the relationship of the release button 25 and the release button spring 30, as well as the opposing action of the latch pin 50 and the latch pin spring 55 as they engage the latch 60. As the end user of the invention depresses the release button 25, the latch 60 is pivotally moved in a rearward position thus releasing the spool latch nodule 36 located on the nylon cord spool 35 and allowing the compression spring 75 that while in the retracted or nested position is biasing to extend the tube sections 90 A, 90 B 90 C, (et al) to their full expanded potential depending on the embodiment of the invention at that time. Once the release button 25 is no longer depressed and the release button spring 30 returns the release button 25 to its original position the latch 60 is pivotally moved forward via the latch pin 50 and the latch pin spring 55 thus engaging the spool latch nodule 36 on the nylon cord spool 35 stopping the further extension of the tube sections 90 A, 90 B 90 C, (et al) as the compression spring 75 located in each tube section 90 A, 90 B 90 C, (et al) attempt to expand to its full expanded potential.

Referring to FIG. 3A a further refinement of the base handle assembly 8 may be seen. FIG. 3A is a sectional view of the area noted as Section “A A” on FIG. 3. The molded plastic handle (R) 15 with the torsion spindle 15 A as an integral part, allow the nylon cord spool 35 to rotate on the said torsion spindle 15 A. Also attach e to the torsion spindle 15 A and holding in a stationary position is the torsion spring 70, said torsion spring 70 is also attached to the nylon cord spool 35 and the spinning of the nylon cord spool 35 with the torsion spring 70 creates a reversing torque of the torsion spring 70, thus keeping a rearward pressure on the nylon cord 40, in an attempt to spool up the cord while the telescoping pole assembly 9 is being retracted into the retracted or nesting position. The molded plastic handle (L) 20 secures the aforementioned assembly via its attachment to the molded plastic handle (R) 15 via a plurality of handle assembly screws 65.

FIG. 3B is a sectional view of the area noted as Section “B B” located on FIG. 3. This view denotes that the molded plastic handle (R) 15 and the molded plastic handle (L) 20 contain a release button 25 and the release button 30 as it interfaces with the latch 60.

FIG. 3C is the cross section of the cord pulley area of the base handle assembly, that guides the nylon cord from the nylon cord spool and into the tubular assembly in a orderly fashion. This area is noted as Section “C-C” on FIG. 3.

FIG. 3D is a cross section of the sectional view noted as Section “D D” on FIG. 3. FIG. 3D depicts the relationship, in detail, of the molded plastic handle (R) 15 and the molded plastic handle (L) 20 as they contain the latch 60 and the latch shaft 61 as shown on the call out found on FIG. 3 and noted as Section “D D”.

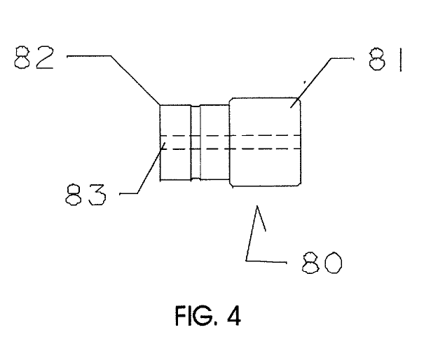

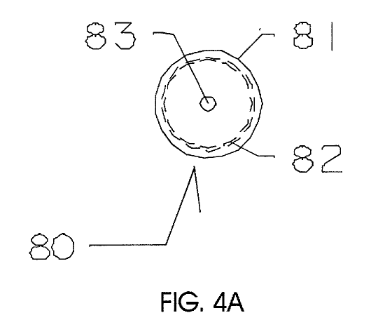

FIG. 4 is a perspective of the tubular guide plug 80. It should be noted that the tubular guide plug 80 has two main embodiments, the larger diameter end of tubular guide plug 81, and the smaller diameter end of tubular guide plug 82. The purpose of this multi sized tubular guide plug 80 is once the smaller diameter end of tubular guide plug 82 is secured into the lower end of the tube sections 90 A, 90 B 90 C, (et al) by crimping, and permanently holding the smaller diameter end of tubular guide plug 82 in place, the smaller diameter tube section 90 A, 90 B 90 C, (et al) is inserted into the larger tube section 90 A, 90 B 90 C, (et al) upward through the guide collar 85 but only as far as the larger diameter end of tubular guide plug 81 will allow as it will be not be allowed to traverse any further than the tubular dimple stop 95. This tubular dimple stop 95 reduces the interior diameter of the tube sections 90 A, 90 B 90 C, (et al) to a suitable size that enables it impede or stop the smaller diameter tube sections 90 A, 90 B 90 C, (et al) from exiting the assembly as the compression spring 75 exerts the pressure to extend. This safety feature is considered an important aspect the invention.

FIG. 4A is an end perspective of the tubular guide plug 80 denoting the differences in the lower end of tubular guide plug 81 and the upper end of tubular guide plug 82. It should be noted that the plug orifice 83 is to allow a continuous feed of the nylon cord 40 throughout the telescoping pole assembly 9 and connecting to the nylon cord spool 35 located in the base handle assembly 8

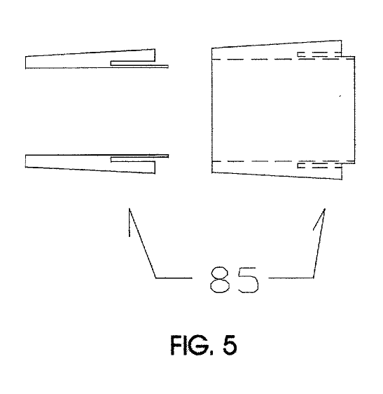

FIG. 5 is a perspective view of the guide collar 85, this is placed on the upper portion or receiving end of the tube sections 90 A, 90 B 90 C, (et al) allowing the two tube sections 90 A, 90 B 90 C, (et al) to expand and retract on a longitudinal axis without friction between these two portions of the invention. The foregoing is considered as illustrative only of the principles of the invention.

Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A telescoping pole assembly apparatus for attachment to a utility device, such as a golf ball retriever, the apparatus comprising:
at least two hollow tubular members sized to fit one within the other, wherein one of said hollow tubular member has an outer surface diameter less than an inner surface diameter of the other hollow tubular member; and
at least one spring between each tubular member biasing the tubular members to their fullest extended capacity or a length desirous of the individual utilizing the invention; and
a cable/cord extending between said tubular members, attached to the end of one of the said hollow tubular members; and
a novel retracting/releasing assembly attached to the opposite end of the other hollow tubular member; and
said novel retracting/releasing apparatus further including a cable/cord colleting spool, said spool winding up and collecting the cable/cord in an orderly fashion, while the tubular assembly has been moved to the retracted or nested position; and
said novel retracting/releasing apparatus still further including a user activated latch to control said spool with regard to releasing or allowing the retraction of the cable/cord aforementioned.

2. The retracting/release assembly of claim 1 further compromising a spool locking/releasing latch assembly with a pivoting action via a release button for extending the tubular assembly to it furthest most position or a length desirous of the individual utilizing the invention, via the spring biasing the tubular members and the opposing pivotal action of a latch pin biasing said locking/ releasing latch as it locks the aforementioned spool in place when the release button is not engaged, holding the extended position stationary; and an integrally formed, longitudinally extended base section, said base section having an outer periphery; said outer periphery being sized to attach to said one hollow tubular member and including a continuous projecting collar engaging with the surface of said one hollow tubular member.

3. The telescoping pole assembly of claim 1 wherein said spring comprises a coiled compression spring

4. The tubular assembly of claim 1 further compromising a guide collar attached to the upper or receiving end of the tubular member allowing smooth longitudinal movement between the two or more tubular members.

5. The tubular assembly of claim 1 further comprises a tubular guide plug attached to the lower, non-receiving end of the tubular members

6. The tubular guide lug of claim 5 comprises an upper and lower end and a plug orifice through the plug allowing the cable/cord connection of the tubular members
